(19) United States
(12) Patent Application Publication
(10) Pub. No.: US 2026/0049857 A1
(43) Pub. Date: Feb. 19, 2026

(54) WIRELESS SIGNAL-PERMEABLE METER ELECTRONICS ENCLOSURE

(71) Applicant: MICRO MOTION, INC., Boulder, CO (US)

(72) Inventors: Sufen QI, Nanjing (CN); Hua JIANG, Nanjing (CN)

(73) Assignee: MICRO MOTION, INC., Boulder, CO (US)

(21) Appl. No.: 19/367,631

(22) Filed: Oct. 23, 2025

Related U.S. Application Data
(63) Continuation of application No. 18/575,180.

(51) Int. Cl. G01F 15/14; G01F 1/84; G01F 15/063

(52) U.S. Cl. CPC G01F 15/14; G01F 1/8409; G01F 15/063

(57) ABSTRACT

A housing 2 is provided, comprising a body 201 further comprising a metal. A cover 200 coupleable to the body 201is provided, and an antenna slot 202 is formed in the housing 2, wherein the antenna slot 202 is filled with a compound 210. A method of forming a housing is provided, comprising forming the housing from a metal and forming an antenna slot therein. The housing is etched, and a compound is inserted into the antenna slot. Meter electronics are housed inside the housing, and a wireless data signal transmitted through the compound to communicate with meter electronics.

### CROSS-REFERENCE TO RELATED APPLICATIONS

This application is a continuation of application Ser. No. 18/575,180, which is the National Stage of International Application No. PCT/CN2021/110226, filed Aug. 3, 2021.

### TECHNICAL FIELD

The embodiments described below relate to meters with an interface and, more particularly, to an enclosure for a meter electronics permeable to wireless signals.

### BACKGROUND

Vibratory meters, such as for example, Coriolis mass flowmeters, liquid density meters, gas density meters, liquid viscosity meters, gas/liquid specific gravity meters, gas/liquid relative density meters, and gas molecular weight meters, are generally known and are used for measuring characteristics of fluids. Generally, vibratory meters comprise a sensor assembly and a meter electronics. The material within the sensor assembly may be flowing or stationary. The vibratory meter may be used to measure a mass flow rate, density, or other properties of a material in the sensor assembly. The meter electronics typically performs calculations to determine values of the mass flow rate, density, and other properties of the material in the sensor assembly.

The meter electronics is usually disposed in an interface, sometimes referred to as a transmitter, that is communicatively and/or mechanically coupled to the sensor assembly. More specifically, the meter electronics may be disposed inside a housing that is typically a rigid structure. FIG. 1 illustrates a prior art housing. The external structure of the transmitter is metal, typically, aluminum. Due to the nature of metal enclosures, and their inherent shielding abilities, wireless signals, such as UHF radio waves, which may include Bluetooth signals, cannot pass through the housing. Therefore, wireless operation and/or controls cannot be transmitted to or received from electronics situated within the housing.

Apertures in the housing for UHF transmission are not always possible based upon the size and dimension of the housing and its related configuration. Furthermore, products that are used in hazardous areas often require particular spacing considerations that constrain aperture size adjustment.

Accordingly, there is a need for a wireless communications-permeable metal housing that still maintains structural integrity necessary for location in hazardous or even explosive atmospheres.

### SUMMARY

According to an embodiment, a method of forming a housing is provided. The method comprises forming the housing from a metal and forming an antenna slot in the housing. The housing is etched and a compound is inserted into the antenna slot. The housing is assembled and meter electronics are housed inside the housing. Meter electronics communicate with a wireless data signal transmitted through the compound.

According to an embodiment, a housing comprises a body further comprising a metal and a cover coupleable to the body. An antenna slot is formed in the housing, wherein the antenna slot is filled with a compound.

### ASPECTS

According to an aspect, a method of forming a housing comprises forming the housing from a metal, forming an antenna slot in the housing, etching the housing, inserting a compound into the antenna slot, and assembling the housing, wherein meter electronics are housed inside the housing. The method further comprises communicating with the meter electronics with a wireless data signal transmitted through the compound.

Preferably, the housing is connected to a flowmeter.

Preferably, the compound comprises a fiber-reinforced resin.

Preferably, etching the housing comprises etching pores having a depth between 20 and 500 nm, and wherein the step of inserting a compound into the antenna slot comprises filling the pores with compound.

Preferably, the step of etching the housing comprises forming pores in the metal having a depth between 20 and 300 nm, and wherein the step of inserting a compound into the antenna slot comprises filling the pores with compound.

Preferably, the step of forming the antenna slot in the housing comprises forming a plurality of resin detents.

According to an aspect, a housing comprises a body comprising a metal, a cover coupleable to the body, and an antenna slot formed in the housing, wherein the antenna slot is filled with a compound.

Preferably, the compound is wireless data transmission permeable.

Preferably, meter electronics is housed therein, and wherein the meter electronics may at least one of send and receive wireless data transmission through the compound.

Preferably, the compound comprises a fiber-reinforced resin.

Preferably, the housing proximate the antenna slot is etched.

Preferably, the etched housing comprises pores having a depth between 20 and 500 nm.

Preferably, the etched housing comprises pores having a depth between 20 and 300 nm.

Preferably, the antenna slot comprises a plurality of resin detents.

### BRIEF DESCRIPTION OF THE DRAWINGS

The same reference number represents the same element on all drawings. It should be understood that the drawings are not necessarily to scale.

FIG. 1 illustrates a prior art vibratory meter housing;

FIG. 2 illustrates a vibratory meter 5 having an improved housing according to an embodiment;

FIG. 3 illustrates the vibratory meter 5 sensor assembly according to an embodiment;

FIG. 4 illustrates a housing 2 according to an embodiment;

FIG. 5A illustrates a cover 200 according to an embodiment;

FIG. 5B illustrates an alternate view of the cover 200 of FIG. 5A;

FIG. 6A illustrates the cover 200 illustrated in FIGS. 5A and 5B having an antenna slot 202.

FIG. 6B illustrates the cover 200 illustrated in FIG. 6A, showing material connection points 206;

FIG. 6C illustrates an alternate view of the cover 200 of FIG. 6B.

FIG. 7A illustrates a cover 200 having a filled antenna slot 202;

FIG. 7B illustrates an alternate view of the cover 200 of FIG. 7A;

FIG. 8 is a flow chart illustrating a method for forming a wireless data transmission-permeable housing.

### DETAILED DESCRIPTION

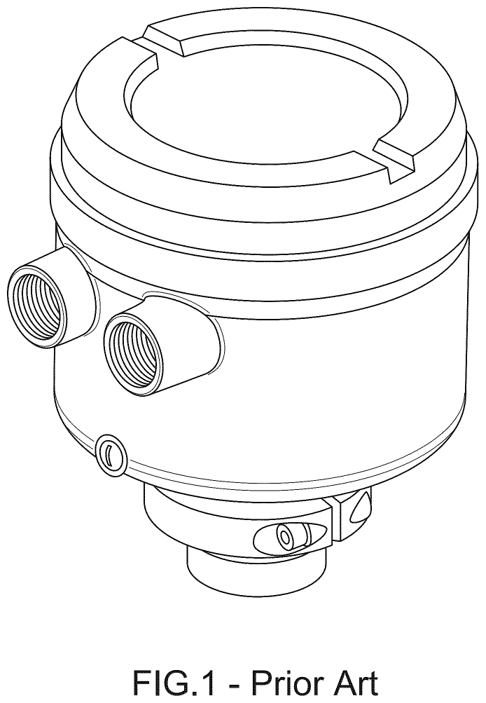

FIGS. 1-8 and the following description depict specific examples to teach those skilled in the art how to make and use the best mode of embodiments of an enclosure for meter electronics. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of using the enclosure. As a result, the embodiments described below are not limited to the specific examples described below, but only by the claims and their equivalents.

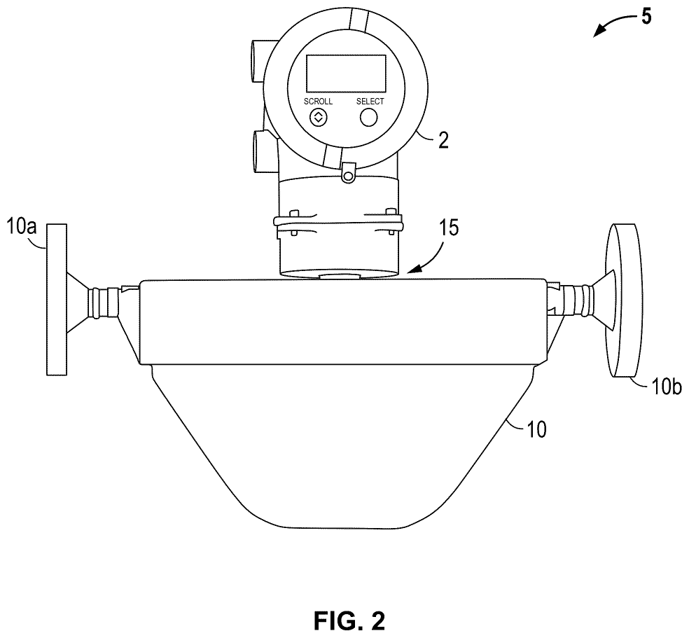

FIG. 2 shows a vibratory meter 5 having a housing 2 according to an embodiment. As shown in FIG. 2, the vibratory meter 5 includes a sensor assembly 10 that is mechanically and communicatively coupled to the housing 2 via a feed through 15. The sensor assembly 10 may be inserted into a process line (not shown) at flanges 10a, 10b to receive and measure, and return, a material to the process line. The housing 2 may enclose a meter electronics.

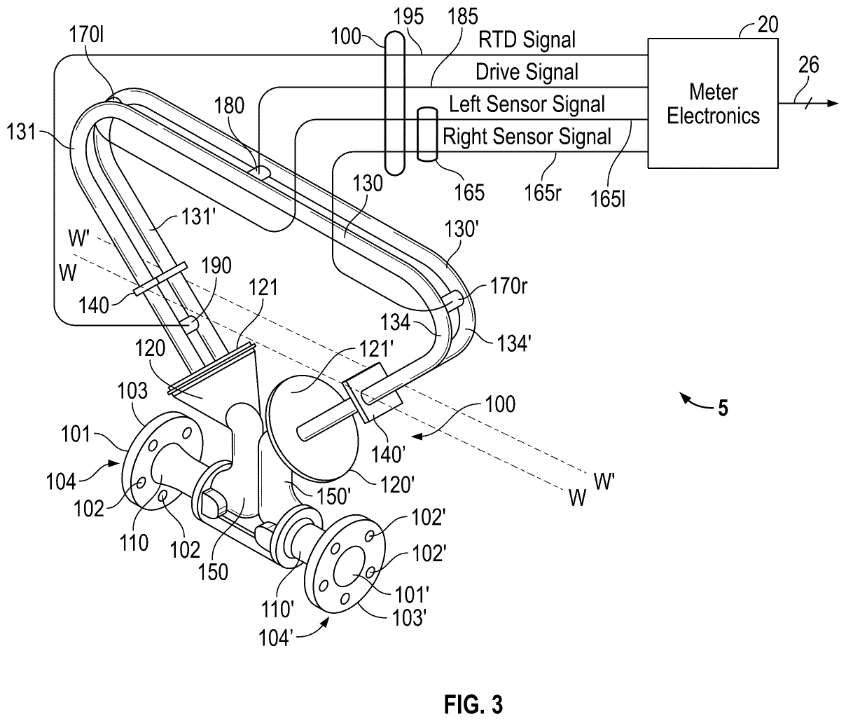

FIG. 3 shows the vibratory meter 5, with the housing 2 not shown for clarity. The vibratory meter 5 comprises a sensor assembly 10 and meter electronics 20, where the meter electronics 20 is disposed in the housing 2 shown in FIG. 1. The sensor assembly 10 responds to mass flow rate and density of a process material. The meter electronics 20 is connected to the sensor assembly 10 via leads 100 to provide density, mass flow rate, and temperature information over port 26, as well as other information.

The sensor assembly 10 includes a pair of manifolds 150 and 150′, flanges 103 and 103′ having flange necks 110 and 110′, a pair of parallel conduits 130 and 130′, driver 180, resistive temperature detector (RTD) 190, and a pair of pick-off sensors 1701 and 170r. Conduits 130 and 130′ have two essentially straight inlet legs 131, 131′ and outlet legs 134, 134′, which converge towards each other at conduit mounting blocks 120 and 120′. The conduits 130, 130′ bend at two symmetrical locations along their length and are essentially parallel throughout their length. Brace bars 140 and 140′ serve to define the axis W and W′ about which each conduit 130, 130′ oscillates. The legs 131, 131′ and 134, 134′ of the conduits 130, 130′ are fixedly attached to conduit mounting blocks 120 and 120′ and these blocks, in turn, are fixedly attached to manifolds 150 and 150′. This provides a continuous closed material path through sensor assembly 10.

When flanges 103 and 103′, having holes 102 and 102′ are connected, via inlet end 104 and outlet end 104′ into a process line (not shown) which carries the process material that is being measured, material enters inlet end 104 of the meter through an orifice 101 in the flange 103 and is conducted through the manifold 150 to the conduit mounting block 120 having a surface 121. Within the manifold 150 the material is divided and routed through the conduits 130, 130′. Upon exiting the conduits 130, 130′, the process material is recombined in a single stream within the block 120′ having a surface 121′ and the manifold 150′ and is thereafter routed to outlet end 104′ connected by the flange 103′ having holes 102′ to the process line.

The conduits 130, 130′ are selected and appropriately mounted to the conduit mounting blocks 120, 120′ so as to have substantially the same mass distribution, moments of inertia and Young's modulus about bending axes W-W and W′-W′, respectively. These bending axes go through the brace bars 140, 140′. Inasmuch as the Young's modulus of the conduits change with temperature, and this change affects the calculation of flow and density, RTD 190 is mounted to conduit 130′ to continuously measure the temperature of the conduit 130′. The temperature of the conduit 130′ and hence the voltage appearing across the RTD 190 for a given current passing therethrough is governed by the temperature of the material passing through the conduit 130′. The temperature dependent voltage appearing across the RTD 190 is used in a well-known method by the meter electronics 20 to compensate for the change in elastic modulus of the conduits 130, 130′ due to any changes in conduit temperature. The RTD 190 is connected to the meter electronics 20 by the lead carrying the RTD signal 195.

Both of the conduits 130, 130′ are driven by driver 180 in opposite directions about their respective bending axes W and W′ and at what is termed the first out-of-phase bending mode of the flow meter. This driver 180 may comprise any one of many well-known arrangements, such as a magnet mounted to the conduit 130′ and an opposing coil mounted to the conduit 130 and through which an alternating current is passed for vibrating both conduits 130, 130′. A suitable drive signal 185 is applied by the meter electronics 20, via a lead, to the driver 180.

The meter electronics 20 receives the RTD signal 195 on a lead, and sensor signals 165 appearing on leads 100 carrying left and right sensor signals 1651, 165r, respectively. The meter electronics 20 produces the drive signal 185 appearing on the lead to driver 180 and vibrate conduits 130, 130′. The meter electronics 20 processes the left and right sensor signals 1651, 165r and the RTD signal 195 to compute the mass flow rate and the density of the material passing through sensor assembly 10. This information, along with other information, is applied by meter electronics 20 over path 26 as a signal. A more detailed discussion of the vibratory meter 5 and meter electronics 20 follows.

A mass flow rate measurement (\dot{m}) can be generated according to the equation:

$$\dot{m} = FCF [ Δ t - Δ {t}_{0} ] . \qquad ( 1 )$$

The Δt term comprises an operationally-derived (i.e., measured) time delay value comprising the time delay existing between the pickoff sensor signals, such as where the time delay is due to Coriolis effects related to mass flow rate through the vibratory meter 5. The measured Δt term ultimately determines the mass flow rate of the flow material as it flows through the vibratory meter 5. The Δt₀ term comprises a time delay at zero flow calibration constant. The Δt₀ term is typically determined at the factory and programmed into the vibratory meter 5. The time delay at zero flow Δt₀ term may not change, even where flow conditions are changing. A mass flow rate of flow material flowing through the flow meter is determined by multiplying a measured time delay by the flow calibration factor FCF. The flow calibration factor FCF is proportional to a physical stiffness of the flow meter.

As to density, a resonance frequency at which each conduit 130, 130′ will vibrate may be a function of the square root of a spring constant of the conduit 130, 130′ divided by the total mass of the conduit 130, 130′ having a material. The total mass of the conduit 130, 130′ having the material may be a mass of the conduit 130, 130′ plus a mass of a material inside the conduit 130, 130′. The mass of the material in the conduit 130, 130′ is directly proportional to the density of the material. Therefore, the density of this material may be proportional to the square of a period at which the conduit 130, 130′ containing the material oscillates multiplied by the spring constant of the conduit 130, 130′. Hence, by determining the period at which the conduit 130, 130′ oscillates and by appropriately scaling the result, an accurate measure of the density of the material contained by the conduit 130, 130′ can be obtained. The meter electronics 20 can determine the period or resonance frequency using the sensor signals 165 and/or the drive signal 185. The meter electronics 20 may include electronics and related circuit boards that are contained and encompassed by the enclosure 2, as is described in more detail in the following.

FIG. 4 illustrates a housing 2 according to an embodiment. The vibratory meter 5 is mechanically and communicatively coupled to the housing 2 via the feed through. The housing 2 may enclose a meter electronics. A cover 200 is coupled to a body 201 of the housing 2. Electrical conduits (not shown) may couple to the housing 2 via junctions 204.

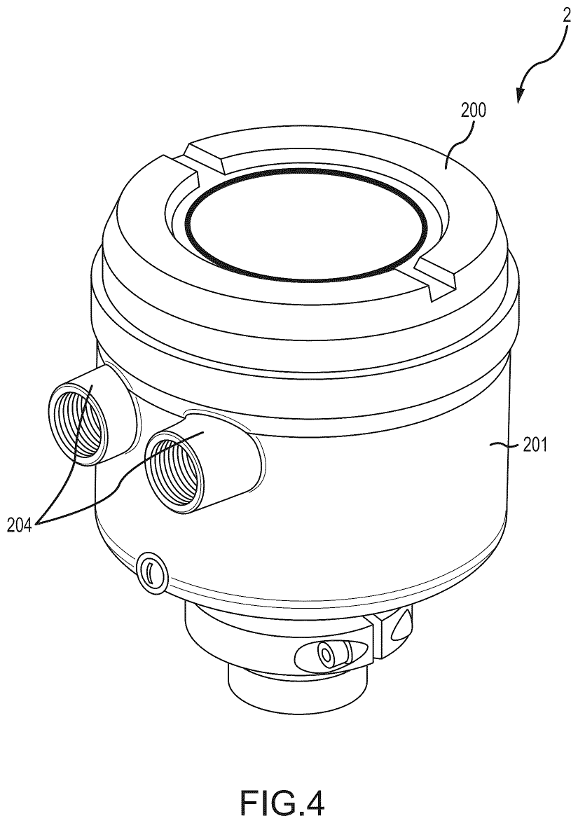

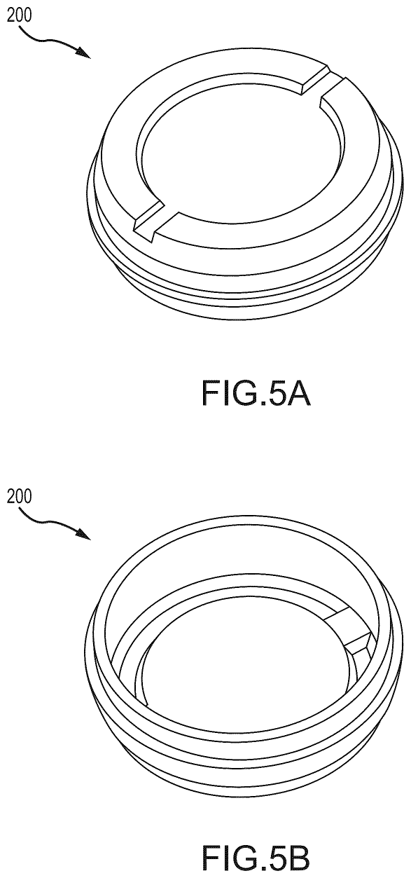

FIGS. 5A and 5B illustrate the cover 200 for the enclosure 2. FIG. 5A shows the outward-facing surface, and FIG. 5B shows the inward-facing surface. A metallic cover of this nature does not let UHF radio waves pass therethrough. However, as illustrated by FIGS. 5A and 5B, this is merely the cover in a configuration from the manufacturing to achieve the general form of the cover 200. Manufacturing may be in the form of machining, casting, additive manufacturing techniques, combinations thereof, and any other manufacturing methodology known in the art.

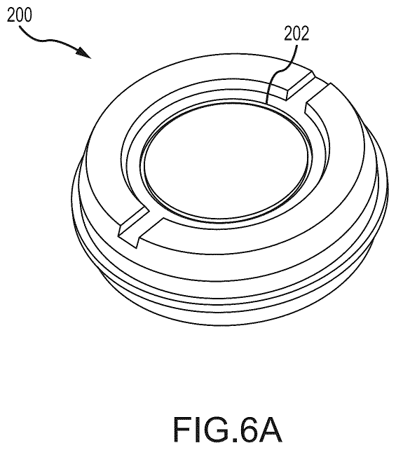

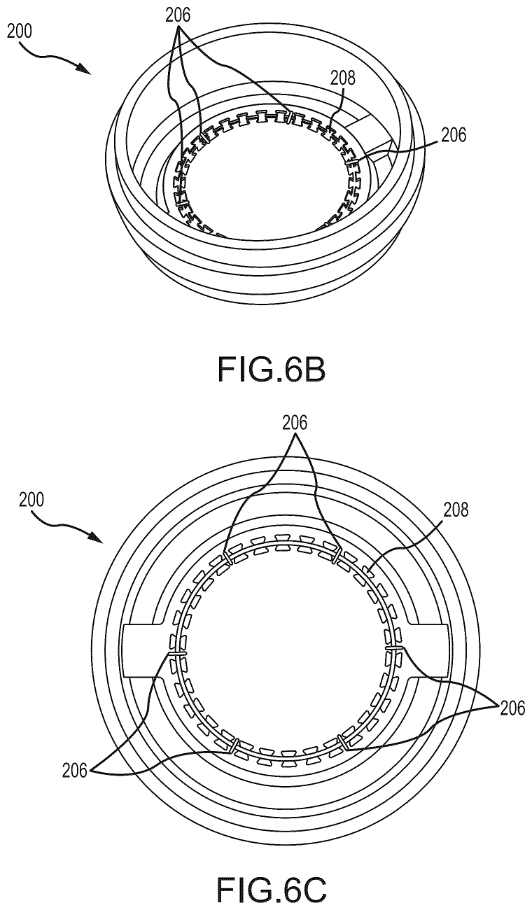

FIG. 6A illustrates the cover 200 illustrated in FIGS. 5A and 5B after a subsequent subtractive manufacturing step to form an antenna slot 202 in the cover 200. It will be appreciated by those skilled in the art that should an additive manufacturing process be employed to form the cover 200 that the antenna slot 202 may be formed while the cover 200 is being manufactured. In an embodiment, any temporary support structure necessary for manufacturing may be utilized, which would be removed to arrive at the structure illustrated in FIG. 5 or an equivalent configuration. Because the metal cover functions as shielding, it will attenuate or totally block UHF radio waves, so it is advantageous to form an antenna slot 202 in the cover 200, thus providing a signal path into and out of the assembled housing 2. In the embodiment shown in FIGS. 6B and 6C, material connection points 206 are defined or created to ensure the requisite strength and structural integrity of the cover 200. In the embodiment shown in FIGS. 6B and 6C, resin detents 208 are defined or created to provide additional space for a resin to occupy and thus provide additional strength and ensure the structural integrity of the cover 200.

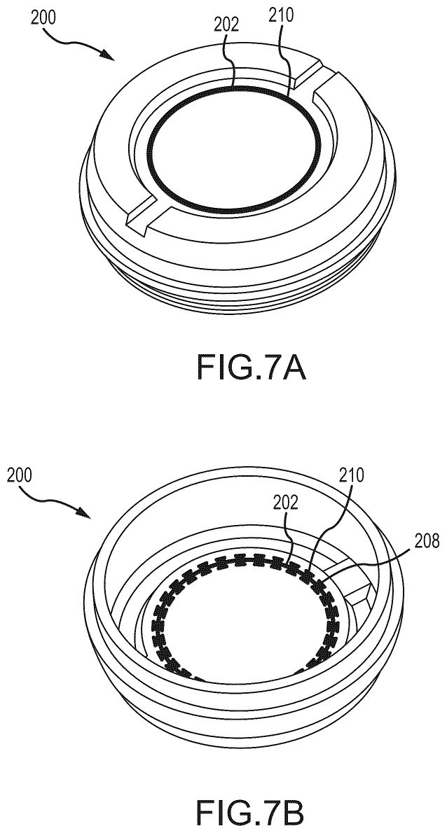

FIGS. 7A and 7B illustrate the filling of the antenna slot 202 and the resin detents 208 with a UHF radio wave-permeable compound 210. This allows wireless data connections, such as Bluetooth, to occur between meter electronics enclosed in the housing 2 and external electronic devices. Other wireless data transmission spectra and standards besides UHF and Bluetooth, respectively, are contemplated for passing through the compound 210. In an embodiment, the compound 210 comprises glass fiber or carbon fiber compounded into resins, such as polyphenylene sulfide (PPS), polyphthalamide (PPA), polybutylene terephthalate (PBT), or polyamide (PA) in order to match the compound's linear expansion coefficients with metal utilized for the housing 2. In embodiments, the metal utilized for the housing is one of aluminum, aluminum alloys, stainless steel, magnesium, magnesium alloys, titanium, and titanium alloys. Such glass fiber or carbon fiber-reinforced compounds enable high adhesion between metal and plastic.

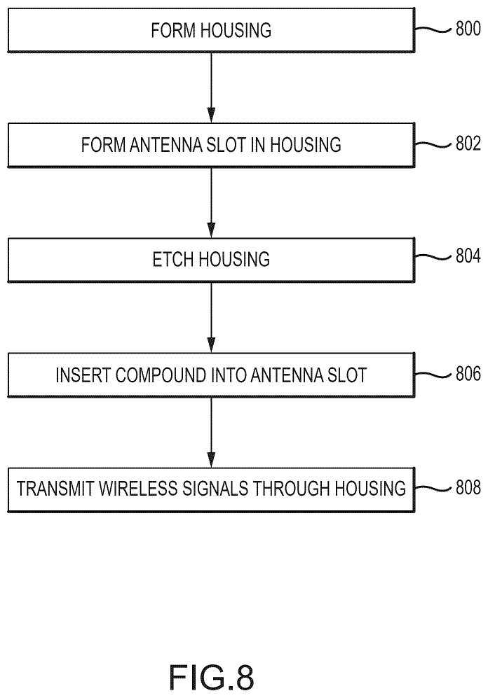

A method for forming a wireless data transmission-permeable housing 2 is provided and illustrated in FIG. 8. The housing 2 is formed from a metal in step 800. As noted above, the metal is one of aluminum, aluminum alloys, stainless steel, magnesium, magnesium alloys, titanium, and titanium alloys. The housing may be machined, cast, additively manufactured, combinations thereof, and any other manufacturing methodology known in the art. The housing comprises a cover 200 and a body 201.

In step 802, an antenna slot 202 is formed in the housing 2. The antenna slot 202 may be formed via a subtractive process, such as machining, for example. The antenna slot 202 may be formed via an additive process, such as 3D printing, for example. Temporary supports may be formed during these steps. Material connection points 206 may be formed during these steps. Resin detents 208 may be defined or created to provide additional space for a resin to occupy during these steps.

In step 804 the housing 2 is etched to create nano-sized pores in the metal. Typically, the housing 2 would initially be degreased and rinsed using standard methods known in the art.

The aluminum alloy may first be immersed in a basic aqueous solution (pH>7), and then rinsed with water. Examples of the base used for the basic aqueous solution include hydroxides of alkali metal hydroxides such as sodium hydroxide (NaOH) and potassium hydroxide (KOH), and soda ash (Na), Anhydrous sodium carbonate, ammonia and the like. Alkaline earth metal hydroxides (Ca, Sr, Ba, Ra) can also be used. In the case of using sodium hydroxide, an aqueous solution having a concentration of 0.1 to several percentage points is preferable, and in the case of using soda ash, the concentration is preferably 0.1 to several percentage points. The housing is immersed for several minutes to treat the surface of the aluminum alloy. By immersion in a basic aqueous solution, the surface of the aluminum alloy dissolves as aluminate ions while releasing hydrogen, and the surface of the aluminum alloy is shaved and a new surface comes out. After this immersion treatment, it is washed with water.

Alternatively, acid etching may be performed at a room temperature or a slightly higher temperature, for example, 20 to 50° C. in an aqueous solution of an acid having a concentration of several percentage points to 40-50%, for example, hydrochloric acid, nitric acid, sulfuric acid, hydrofluoric acid and the like may be used. The housing 2 is immersed for several seconds to several minutes.

In addition, a combined method of performing both alkali etching, rising with water, and then performing acid etching may be performed. Subsequent water rinses, alkali etching, and/or acid etching steps may be performed.

For etching aluminum or an aluminum alloy, for example, the housing 2 may be further finely etched with a weakly basic aqueous solution and at the same time an aqueous amine compound solution, such that amine compound molecules are adsorbed on the surface of the aluminum alloy. An example of a solution is an aqueous solution of ammonia, hydrazine, or a water-soluble amine compound. The surface of the aluminum alloy is etched very finely as a result of such a process, having pores approximately between 20 and 500 nm in depth. In a preferred embodiment, the pores are between 20 and 300 nm in depth. The nitrogen compound derived from ammonia, hydrazine, or a water-soluble amine compound remains present on the surface.

The purpose of this step is to delicately attack the surface of the aluminum alloy to cause pore formation and to adsorb these nitrogen-containing compounds. The water-soluble amine-based compound, particularly, methylamine (CH₃NH₂), Dimethylamine ((CH₃)₂NH), trimethylamine ((CH₃)₃N), ethylamine (C₂H₅NH₂), Diethylamine ((C₂H₅)₂NH), triethylamine ((C₂H₅)₃N), ethylenediamine (H₂NCH₂CH₂NH₂), Ethanolamine (monoethanolamine (HOCH)₂CH₂NH₂), Allylamine (CH₂CHCH₂NH₂), Diethanolamine ((HOCH₂CH₂)₂NH), aniline (C₆H₇N), triethanolamine ((HOCH₂CH₂)₃N) and the like are preferable.

For example, a 3 to 10% hydrazine monohydrate aqueous solution may be heated to 40 to 50° C., and the housing 2 is immersed for several minutes and washed with water. Similarly, 15 to 25% ammonia at a temperature of 15 to 25° C. for 10 to 30 minutes followed by rinsing with water may be employed. When other water-soluble amines are used, the temperature, concentration, and immersion time will vary depending on the aluminum alloy.

For titanium and its alloys, an aqueous solution of an ammonium monohydrodifluoride with a concentration of a few percentage points and a temperature of 50 to 70° C. may be employed.

For magnesium and its alloys, either chemical conversion treatment or electrolytic oxidation is contemplated. A two-stage immersion treatment may be employed where, first, fine chemical etching is performed by immersing the housing in a weak acidic aqueous solution for a short time. In the fine etching process, an organic carboxylic acid having a pH of 2.0 to 6.0, such as a weakly acidic aqueous solution such as acetic acid, propionic acid, citric acid, benzoic acid, phthalic acid, phenol, and a phenol derivative may be used. An immersion time of 15 to 40 seconds is preferable, but longer times may be necessary depending on process conditions.

A specific example of magnesium treatment is described. The magnesium housing 2 is immersed in a 0.1 to 0.5% strength hydrated citric acid solution at about 40° C. for 15 to 60 seconds and finely etched. The part is then rinsed with water. Next, as a chemical conversion treatment solution, an aqueous solution containing potassium permanganate 1-5%, acetic acid 0.5-2%, and hydrated sodium acetate 0.1-1.0% may be utilized at 40-60° C. The magnesium alloy part is immersed for 0.5 to 2 minutes, washed with water, and placed in a hot air drier at 60 to 90° C. for 5 to 20 minutes for drying.

In another example of magnesium treatment, the magnesium housing is finely etched by immersion in a 0.1 to 0.5% strength hydrated citric acid aqueous solution at about 40° C. for 15 to 60 seconds. The part is then rinsed with water. Next, as a chemical conversion treatment solution, an aqueous solution of chromic anhydride (chromium trioxide) having a concentration of 15 to 20% is prepared at 60 to 80° C., and the housing 2 is immersed in this for 2 to 4 minutes and washed with water. This is put into a warm air dryer set at 60 to 90° C. for 5 to 20 minutes and dried.

These are only examples of various chemical etching processes for aluminum, magnesium, and titanium and their respective alloys. Other etching solutions and methodologies are contemplated and will be recognized to those skilled in the art. The particular etching methodology is not crucial to the present invention as long as nano-scale pores are formed on the surface of the housing 2.

In step 806, the compound 210 is inserted into the antenna slot. The housing may be inserted into the mold of an injection molding machine and injection molding with a thermoplastic resin material may be effectuated. At high temperature and high pressure, the compound 210 is forced into the treated metal housing antenna slot 202 and resin detents 208 so that the compound 210 and the nanoscale holes on the metal surface are bonded. As noted above, the compound 210 comprises glass fiber or carbon fiber compounded into resins, such as polyphenylene sulfide (PPS), polyphthalamide (PPA), polybutylene terephthalate (PBT), or polyamide (PA) in order to match the compound's linear expansion coefficients with metal utilized for the housing 2. Glass fiber or carbon fiber may be up to 45% weight.

The cured compound 210 may be machined to provide a finished surface. In an embodiment, the junctions 204 may be machined off of the housing 2 after the compound has cured.

In step 808, the housing is assembled with electronics provided therein. Means for sending, receiving, or both sending and receiving a wireless signal is provided with the electronics. The particular electronics, receiver, or transmitter may be chosen according to design preference and application. For example, a Bluetooth device may be utilized in the housing should it be desirous to connect to the electronics within the housing. With the housing 2 assembled and fully sealed, wireless signals pass through the compound-filled antenna slot 802. The antenna slot 802 is illustrated as being formed in the cover 200 of the housing 2, but it is also contemplated that the antenna slot 802 is formed in the body 201 of the housing 2.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other housings for meter electronics and not just to the embodiments described above and shown in the accompanying figures. Accordingly, the scope of the embodiments described above should be determined from the following claims.

We claim:

1. A method of forming a housing, the method comprising:
forming the housing from a metal;
forming an antenna slot in the housing;
etching the housing;
inserting a compound into the antenna slot;
assembling the housing, wherein meter electronics are housed inside the housing;
communicating with the meter electronics with a wireless data signal transmitted through the compound.

2. The method of forming a housing of claim 1, wherein the housing is connected to a flowmeter.

3. The method of forming a housing of claim 1, wherein the compound comprises a fiber-reinforced resin.

4. The method of forming a housing of claim 1, wherein etching the housing comprises etching pores having a depth between 20 and 500 nm, and wherein the step of inserting a compound into the antenna slot comprises filling the pores with compound.

5. The method of forming a housing of claim 1, wherein the step of etching the housing comprises forming pores in the metal having a depth between 20 and 300 nm, and wherein the step of inserting a compound into the antenna slot comprises filling the pores with compound.

6. The method of forming a housing of claim 1, wherein the step of forming the antenna slot in the housing comprises forming a plurality of resin detents.

7. A housing (2) comprising:
a body (201) comprising a metal;
a cover (200) coupleable to the body (201);
an antenna slot 202 formed in the housing (2), wherein the antenna slot 202 is filled with a compound (210).

8. The housing (2) of claim 7, wherein the compound (210) is wireless data transmission permeable.

9. The housing (2) of claim 7, wherein meter electronics (20) is housed therein, and wherein the meter electronics (20) may at least one of send and receive wireless data transmission through the compound (210).

10. The housing (2) of claim 7, wherein the compound comprises a fiber-reinforced resin.

11. The housing (2) of claim 7, wherein the housing (2) proximate the antenna slot (202) is etched.

12. The housing (2) of claim 11, wherein the etched housing comprises pores having a depth between 20 and 500 nm.

13. The housing (2) of claim 11, wherein the etched housing comprises pores having a depth between 20 and 300 nm.

14. The housing (2) of claim 7, wherein the antenna slot (202) comprises a plurality of resin detents.
